(19) United States
(12) Patent Application Publication
(10) Pub. No.: US 2016/0118652 A1
(43) Pub. Date: Apr. 28, 2016

(54) ANODE MATERIAL FOR LITHIUM ION BATTERY AND LITHIUM ION BATTERY INCLUDING THE SAME

(71) Applicant: Industrial Technology Research Institute, Hsinchu (TW)

(72) Inventors: Wei-Hsin Wu, Kaohsiung City (TW); Yueh-Wei Lin, Hsinchu County (TW); Chia-Chen Fang, Taipei City (TW); Jen-Jeh Lee, Taipei City (TW)

(21) Appl. No.: 14/923,450

(22) Filed: Oct. 27, 2015

Related U.S. Application Data
(60) Provisional application No. 62/068,767, filed on Oct. 27, 2014.

(30) Foreign Application Priority Data
Sep. 16, 2015 (TW) 104130619

(51) Int. Cl. H01M 4/36; H01M 4/587; H01M 4/58; H01M 4/38; H01M 4/485; H01M 10/0525; H01M 4/60

(52) U.S. Cl. CPC H01M 4/366; H01M 10/0525; H01M 4/587; H01M 4/60; H01M 4/386; H01M 4/485; H01M 4/5825; H01M 4/582; H01M 4/382; H01M 2004/027

(57) ABSTRACT

Provided is an anode material for a lithium ion battery including an anode active material, an organic modified layer, and a lithium-containing inorganic layer. The organic modified layer is disposed on the anode active material. The lithium-containing inorganic layer is disposed on the organic modified layer. Moreover, based on 100 parts by weight of the anode active material, the organic modified layer accounts for about 0.1 to 5 parts by weight, and the lithium-containing inorganic layer accounts for about 0.1 to 20 parts by weight. A lithium ion battery including the anode material is further provided.

### CROSS-REFERENCE TO RELATED APPLICATION

This application claims the priority benefits of U.S. provisional application Ser. No. 62/068,767, filed on Oct. 27, 2014 and Taiwan application serial no. 104130619, filed on Sep. 16, 2015. The entirety of each of the above-mentioned patent applications is hereby incorporated by reference herein and made a part of this specification.

### TECHNICAL FIELD

The disclosure relates to an anode material for a lithium ion battery and a lithium ion battery including the same.

### BACKGROUND

Almost all current portable electronic devices rely on rechargeable lithium ion batteries for power. A variety of continuous development efforts of the lithium ion batteries have therefore emerged, such as increasing the capacitance capability, power capacity, lifetime and safety features while reducing costs.

However, in prior art, an anode electrode plate in the lithium ion battery is mostly a graphitized carbon material having a laminated structure, and how to prevent delamination of such graphitized carbon material and increase the reversible capacitance and therefore to prolong the lifetime of the battery are important research objectives.

### SUMMARY

One of exemplary embodiments comprises an anode material for a lithium ion battery including an anode active material, an organic modified layer, and a lithium-containing inorganic layer. The organic modified layer is disposed on the anode active material. The lithium-containing inorganic layer is disposed on the organic modified layer. Moreover, based on 100 parts by weight of the anode active material, the organic modified layer accounts for about 0.1 to 5 parts by weight, and the lithium-containing inorganic layer accounts for about 0.1 to 20 parts by weight.

One of exemplary embodiments comprises an anode material for a lithium ion battery including a core, a first shell layer, and a second shell layer. The core consists mainly of the anode active material. The first shell layer covers the core and consists mainly of an organic material. The second shell layer is disposed on the first shell layer and includes at least one of lithium, lithium fluoride (LiF), lithium phosphate (Li₃PO₄), lithium disilicate (Li₂Si₂O₅), lithium metasilicate (Li₂SiO₃), lithium orthosilicate (Li₄SiO₄), lithium oxosilicate (Li₈SiO₆), lithium oxide (Li₂O), and lithium carbonate (Li₂CO₃).

One of exemplary embodiments comprises a lithium ion battery including the above anode material.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional of an anode material for a lithium ion battery according to an exemplary embodiment of the disclosure.

FIG. 2 is a schematic cross-sectional of an anode electrode plate for a lithium ion battery according to an exemplary embodiment of the disclosure.

FIG. 3 is a schematic cross-sectional of a lithium ion battery according to an exemplary embodiment of the disclosure.

FIG. 4 is a graph of the measurement results of charge and discharge cycles of the lithium battery of each of Examples 2 to 3 and Comparative Examples 1, 4, and 5.

FIG. 5 is a graph of the measurement results of charge and discharge cycles of the lithium battery of each of Example 3 and Comparative Examples 5 to 8.

FIG. 6 is a graph of charge/discharge of the lithium battery of each of Example 3 and Comparative Example 1.

FIG. 7 is a graph of the measurement results of charge and discharge cycles of the lithium half-cell of each of Example 4 and Comparative Examples 9 to 10.

FIG. 8 is a graph of the measurement results of a conventional lithium battery and the lithium battery of the disclosure in different supplement lithium amounts.

### DETAILED DESCRIPTION OF DISCLOSED EMBODIMENTS

The disclosure discloses an anode material for a lithium ion battery and a lithium ion battery containing the same. The structural stability of the anode material can be maintained in an electrochemical reaction, and the cycle life of long-term charges and discharges can be increased.

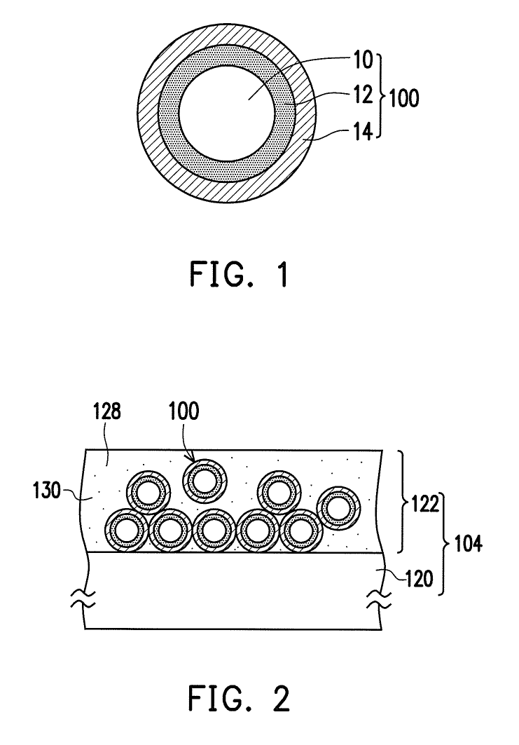

FIG. 1 is a schematic cross-sectional of an anode material for a lithium ion battery according to an exemplary embodiment of the disclosure.

Referring to FIG. 1, an anode material 100 for a lithium ion battery includes a core 10, a first shell layer 12, and a second shell layer 14. The core 10 consists mainly of an anode active material. In an exemplary embodiment, the anode active material includes graphite, graphene, hard carbon, soft carbon, single-walled carbon nanotubes (SWCNT), multi-walled carbon nanotubes (MWCNT), carbon fiber, carbon alloy, carbon metal oxide, a Si/C composite material, mesocarbon micro beads (MCMB), mesophase graphite, mesoporous graphite, or a combination thereof. In an exemplary embodiment, the anode active material consists mainly of a carbon material. For instance, the anode active material includes 90 wt % or more of mesophase carbon microbeads, mesophase graphite, or a combination thereof, and no more than a total amount of 10 wt % of a carbon conducting agent and a binder. In another exemplary embodiment, the anode active material consists mainly of a carbon material and a silicon material. For instance, the anode active material can be a Si/C composite material such as a composite material including a silicon oxide core and a carbon/graphite shell.

The first shell layer 12 covers the core 10 and consists mainly of an organic material. The first shell layer 12 is an organic modified layer. In an exemplary embodiment, the first shell layer 12 can be a solid electrolyte interface (SEI) film or an electrode protective layer for maintaining the structural stability of the anode material in an electrochemical reaction, and as a result battery lifetime is maintained.

In an exemplary embodiment, the first shell layer 12 includes a polymer monomer, such as maleimide, furan, thiophene, pyrrole, alkyne, alkene, cycloalkene, a derivative thereof, or a combination thereof.

In an exemplary embodiment, the first shell layer 12 includes N,N′-(4,4′-diphenylmethane)bismaleimide, N-phenyl maleimide, N,N′,N″-(4,4′,4″-phenylmethane)maleimide, N,N′-(4,4′-diphenyl ether)bismaleimide, or a combination thereof.

In an exemplary embodiment, the first shell layer 12 includes about 5 to 15 parts by weight of N-phenyl maleimide, about 100 parts by weight of N,N′-(4,4′-diphenylmethane)bismaleimide, and about 5 to 15 parts by weight of N,N′,N″-(4,4′,4″-phenylmethane)maleimide. The first shell layer 12 of the present embodiment has good processability.

In an exemplary embodiment, the first shell layer 12 includes a meta-stable nitrogen-containing polymer, such as polymaleimide having a weight-average molecular weight of about 100,000 to 1,000,000 or a derivative thereof. In an exemplary embodiment, the meta-stable nitrogen-containing polymer is a polymer having a narrow molecular weight distribution, wherein the molecular weight distribution index thereof is about 1.1 to 1.7, and the GPC peak time thereof is about 19 to 24 minutes. In an exemplary embodiment, polydispersity index (PDI) is defined as weight average molecular weight divided by number average molecular weight (Mw/Mn).

In an exemplary embodiment, the meta-stable nitrogen-containing polymer consists mainly of a reaction of a compound A and a compound B, wherein the molar ratio of the compound A to the compound B is about 10:1 to 1:10.

In an exemplary embodiment, the compound B is represented by one of formulas (1) to (9):

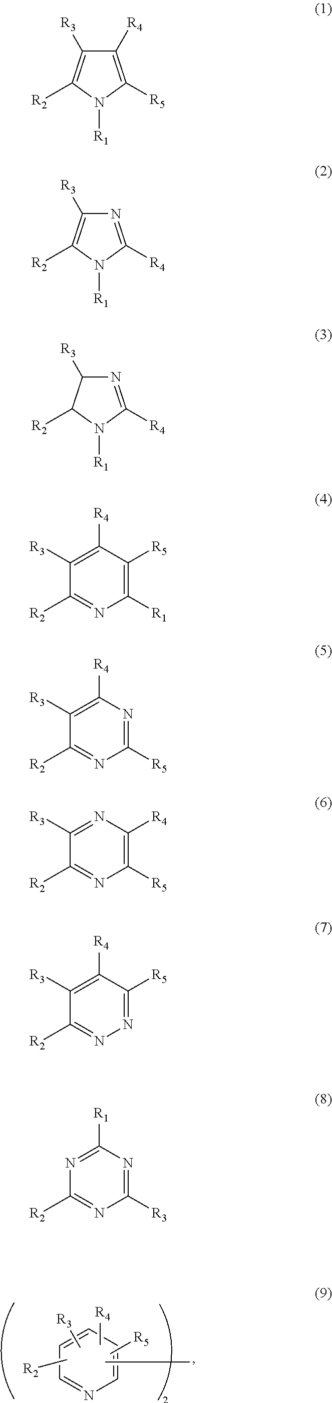

wherein R₁ is hydrogen, alkyl, alkenyl, phenyl, dimethylamino, or —NH₂; and R₂, R₃, R₄, and R₅ are each independently hydrogen, alkyl, alkenyl, halo, or —NH₂.

For instance, the compound B can be selected from the group consisting of imidazole, an imidazole derivative, pyrrole, a pyrrole derivative, pyridine, 4-tert-butylpyridine, 3-butylpyridine, 4-dimethylaminopyridine, 2,4,6-triamino-1,3,5-triazine, 2,4-dimethyl-2-imidazoline, pyridazine, pyrimidine, and pyradine.

In an exemplary embodiment, the compound A is represented by one of formulas (10) to (13) or a combination thereof:

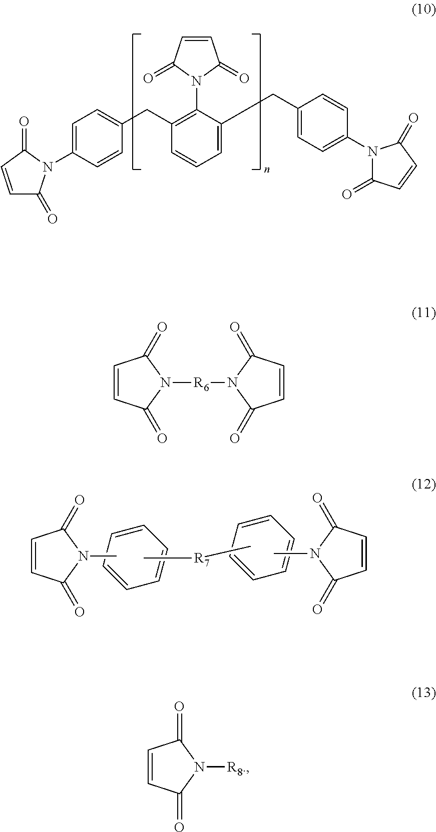

wherein n is an integer of 0 to 4;

R₆ is —RCH₂R′—, —RNHR—, —C(O)CH₂—, —R′OR″OR′—, —CH₂OCH₂—, —C(O)—, —O—, —O—O—, —S—, —S—S—, —S(O)—, —CH₂S(O)CH₂—, —(O)S(O)—, —C₆H₄—, —CH₂(C₆H₄)CH₂—, —CH₂(C₆H₄)(O)—, —CH₂—(NC₂H₄)—C₂H₄—, siloxane, biphenylenyl, substituted phenylene or substituted biphenylenyl, R is C₁₋₄ alkylene, R′ is C₁₋₄ alkylene, biphenylenyl, substituted alkylene, substituted phenylene or substituted biphenylenyl, R″ is C₁₋₄ alkylene, —C₆H₄—C(CF₃)₂—C₆H₄—, biphenylenyl or substituted biphenylenyl;

R₇ is RCH₂—, —CH₂—(O)—, —C(CH₃)₂—, —O—, —O—O—, —S—, —S—S—, —(O)S(O)—, —C(CF₃)₂— or —S(O)—, R is C₁₋₄ alkylene; and

R₈ is hydrogen, C₁₋₄ alkyl, phenyl, benzyl, cyclohexyl, —SO₃H, —C₆H₄CN, N-methoxy carbonyl, —(C₆H₄)—O(C₂H₄O)—CH₃, —C₂H₄—(C₂H₄O)₁₁—OCH₃ or —C(O)CH₃.

In an exemplary embodiment, a diene-containing functional group or a dienophile functional group of an unsaturated compound of the first shell layer 12 can be reacted with the surface of the carbon-containing core 10 in an addition reaction to form a chemical bond, such as a chemical covalent bond. Since the surface energy of a modified carbon-containing substrate is increased after the first shell layer 12 is bonded to the surface of the carbon-containing core 10, an anode electrode plate can be more effectively immersed in a highly polar electrolyte solution, and therefore the solid-liquid interface impedance between the carbon-containing substrate and the electrolyte solution can be reduced. In other words, the first shell layer 12 can increase the electrochemical activity of the carbon material surface and improve the interface compatibility of the carbon-containing substrate surface and the electrolyte solution, and at the same time maintain the chemical resistance and the integrity of the original substrate. Therefore, the carbon-containing substrate is not readily eroded by the electrolyte solution, the thickness of the carbon-containing substrate can be maintained and is not readily changed, the carbon-containing substrate is not readily cracked, and the material and a current collector are tightly adhered.

In another exemplary embodiment, chemical bonding does not occur between the core 10 and the first shell layer 12, and only physical adsorption phenomenon occurs, such as dipole-dipole interaction, dipole-induced dipole interaction, or n-n interaction. More specifically, the organic monomer or organic polymer forming the first shell layer 12 covers or winds the surface of the core 10 via a method of physical adsorption.

The second shell layer 14 is disposed on the first shell layer 12. In an exemplary embodiment, the second shell layer 14 includes a lithium-containing inorganic material. The second shell layer 14 is a lithium-containing inorganic layer for supplementing capacitance lost due to the SEI film. In an exemplary embodiment, the second shell layer 14 includes at least one of lithium, lithium fluoride (LiF), lithium phosphate (Li₃PO₄), lithium disilicate (Li₂Si₂O₅), lithium metasilicate (Li₂SiO₃), lithium orthosilicate (Li₄SiO₄), lithium oxosilicate (Li₈SiO₆), lithium oxide (Li₂O), and lithium carbonate (Li₂CO₃). In an exemplary embodiment, the second shell layer 14 includes a mixture of lithium, lithium oxide, and lithium carbonate.

Moreover, based on 100 parts by weight of the core 10 (anode active material), the first shell layer 12 accounts for about 0.1 to 5 parts by weight and the second shell layer accounts for about 0.1 to 20 parts by weight. When the content of the first shell layer 12 is too low, the SEI protective film may not be formed on the anode active material. When the content of the first shell layer 12 is too high, the SEI protective film is too thick such that the capacitance may be reduced. When the content of the second shell layer 14 is too low, the supplement lithium amount may be insufficient such that the capacitance is reduced. When the content of the second shell layer 14 is too high, the resistance of the electrode may be increased.

In an exemplary embodiment, when the anode active material consists mainly of a carbon material, based on 100 parts by weight of the anode active material, the organic modified layer accounts for about 0.5 to 1 parts by weight, and the lithium-containing inorganic layer accounts for about 3 to 6 parts by weight. In another exemplary embodiment, when the anode active material consists mainly of a carbon material and a silicon material, based on 100 parts by weight of the anode active material, the organic modified layer accounts for about 1 to 5 parts by weight, and the lithium-containing inorganic layer accounts for about 15 to 20 parts by weight.

Moreover, the material and the content of each of the core 10 and the first shell layer 12 are not limited to the above embodiments, as long as the thickness of the first shell layer 12 can effectively maintain the structural stability of the anode active material without substantially affecting the initial capacitance. In an exemplary embodiment, the thickness of the first shell layer 12 or the organic modified layer is from about 15 nm to about 20 nm. When the thickness of the first shell layer 12 is less than 15 nm, the structural stability of the anode active material cannot be effectively maintained. When the thickness of the first shell layer 12 is greater than 20 nm, the initial capacitance is significantly reduced.

The inventors indicate that, in the disclosure, the sequential arrangement of the anode carbon material, the organic SEI film, and the lithium-containing inorganic layer has an unexpected effect. More specifically, an organic SEI film is first actively formed on the anode carbon material to strengthen the structure of the anode material. Then, a lithium-containing inorganic layer is formed on the SEI protective film to supplement the lost lithium content and increase the capacitance. In contrast, when the SEI protective film is passively grown, i.e., SEI is grown at the beginning of the electrochemical reaction of the battery (i.e., beginning of charge and discharge), the anode carbon material, the lithium-containing inorganic layer, and the organic SEI film may be formed in that undesired order, and the structure of the anode material thus formed is weak and a delamination reaction of the carbon material readily occurs.

FIG. 2 is a schematic cross-sectional of an anode electrode plate for a lithium ion battery according to an exemplary embodiment of the disclosure.

Referring to FIG. 2, an anode electrode plate 104 includes a current collector 120 and an anode material layer 122. The anode material layer 122 is located on the current collector 120, and the anode material layer 122 contains, for instance, a plurality of the anode materials 100 shown in FIG. 1. In an exemplary embodiment, the anode material layer 122 can further include a conducting agent 128 and a binder 130.

In the following, the method of manufacturing the anode electrode plate is explained, wherein the organic modified layer can be formed on the anode active material via a method of chemical grafting or physical adsorption.

Preparation of Chemical Graft-Modified Anode Electrode Plate

Step (A): an anode active material (such as mesophase graphite or a Si/C composite material) and N,N′-(4,4′-diphenylmethane)bismaleimide are mixed in an organic solvent (such as gamma-butyrolactone (GBL)), and an addition reaction (such as Diels-Alder reaction) is performed to generate chemical bonding between the organic material and the anode active material. In an exemplary embodiment, the concentrations of the reactants in the reaction system are adjusted and the reaction temperature is controlled to be about 70° C. or less to perform the reaction for about 1 to 4 days. Then, after the reaction system is cooled down to the room temperature, the product is filtered by a centrifuge, and the product is repeatedly washed by using ultrasonic oscillation with tetrahydrofuran (THF). Then, drying is performed at 50° C. to obtain a product (A), wherein based on 100 parts by weight of the anode active material, N,N′-(4,4′-diphenylmethane)bismaleimide accounts for about 0.1 to 5 parts by weight.

Then, the product (A), a conducting agent, and a binder are mixed at a ratio. For instance, about 90 parts by weight of the product (A), about 5 parts by weight of the conducting agent, and about 5 parts by weight of the binder are mixed, and then the mixture is disposed on a current collector. In an exemplary embodiment, 90 parts by weight of the product (A) (diameter of about 1 μm to about 30 μm) and 3 to 10 parts by weight of a fluorine resin binder are dissolved in N-methyl-2-pyrrolidone (NMP), and after uniform stirring, the mixture is coated on a copper foil roll having a length of about 300 m, a width of about 35 cm, and a thickness of about 10 μm to form an anode roll. After the anode roll is rolled and cut into strips, vacuum drying is performed at 110° C. for 4 hours to obtain an anode electrode plate.

Then, a lithium-containing inorganic material (such as a mixture of lithium, lithium oxide, and lithium carbonate) is disposed on the obtained anode electrode plate and rolled such that the lithium-containing inorganic material is completely activated, wherein based on 100 parts by weight of the anode active material, the lithium-containing inorganic material accounts for about 0.1 to 20 parts by weight. In an exemplary embodiment, the lithium-containing inorganic material is placed in an argon gas environment at room temperature for 18 hours to form the chemical graft-modified anode electrode plate of the disclosure.

Preparation of Physical Adsorption-Modified Anode Electrode Plate

An anode active material (such as mesophase graphite or a Si/C composite material), a conducting agent, a binder, and an organic material (such as N,N′-(4,4′-diphenylmethane)bismaleimide or meta-stable nitrogen-containing polymer) are mixed at a ratio. For instance, about 90 parts by weight of the anode active material, about 5 parts by weight of the conducting agent, about 5 parts by weight of the binder, and about 0.1 to 5 parts by weight of the organic material are mixed, and then the mixture is disposed on a current collector. Physical adsorption of, for instance, dipole-dipole interaction and a π-π interaction is generated between the organic material and the anode active material. In an exemplary embodiment, after the mixture is uniformly stirred, the mixture is coated on a copper foil roll having a length of about 300 m, a width of about 35 cm, and a thickness of about 10 μm to form an anode roll. After the anode roll is rolled and cut into strips, vacuum drying is performed at 110° C. for 4 hours to obtain an anode electrode plate.

Then, a lithium-containing inorganic material (such as a mixture of lithium, lithium oxide, and lithium carbonate) is disposed on the obtained anode electrode plate and rolled such that the lithium-containing inorganic material is completely activated, wherein based on 100 parts by weight of the anode active material, the lithium-containing inorganic material accounts for about 0.1 to 20 parts by weight. In an exemplary embodiment, the lithium-containing inorganic material is placed in an argon gas environment at room temperature for 18 hours to form the physical adsorption-modified anode electrode plate of the disclosure.

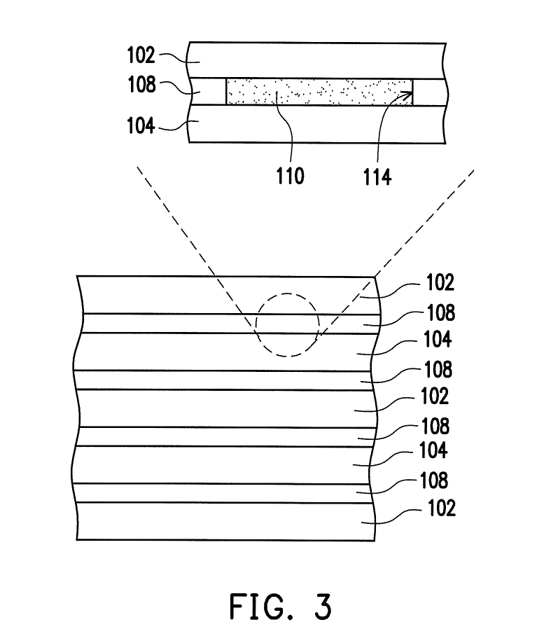

FIG. 3 is a schematic cross-sectional of a lithium ion battery according to an exemplary embodiment of the disclosure.

Referring to FIG. 3, a lithium ion battery 100 includes a plurality of cathode electrode plates 102, a plurality of anode electrode plates 104, a plurality of separators 108, and an electrolyte solution 110. The cathode electrode plates 102 and the anode electrode plates 104 are alternatively arranged and are stacked on one another. For a pair of one cathode electrode plate 102 and one anode electrode plate 104, and one separator 108 is disposed between each of the cathode electrode plates 102 and the anode electrode plates 104. Each of the separators 108 is, for instance, a porous structure. That is, pores 114 of each of the separators 108 are uniformly distributed in the entire separator 108. The stacked structure of the cathode electrode plates 102, the separators 108, and the anode electrode plates 104 is immersed in the electrolyte solution 110. The electrolyte solution 110 is filled in the entire battery interior. In other words, the spaces between the cathode electrode plates 102, the anode electrode plates 104 and the separators 108 are flooded with the electrolyte solution 110, i.e., the pores 114 of the separators 108 are flooded with the electrolyte solution 110. Besides, the shape of the pores 114 is not limited to the figure.

In the following, several Examples and Comparative Examples are provided to describe the efficacy of the disclosure.

Charge and Discharge Cycle Test of Lithium Battery

Two button-type batteries (size CR2032) are assembled, wherein the cathode electrode plates of the batteries adopt lithium cobalt oxide (LiCoO₂), the anode electrode plates adopt materials as shown in Table 1, and the separators are PP/PE/PP three-layer films. The electrolyte solution is formed by dissolving 1.1 M of LiPF₆ in a mixed solvent of propylene carbonate (PC), ethylene carbonate (EC), and diethyl carbonate (DEC) (volume ratio EC/PC/DEC=3/2/5). A charge and discharge cycle test is performed on the manufactured lithium batteries. Three cycles are performed by charging and discharging at 0.1 C, then the 4^{th} to 65^{th} cycles are performed by charging and discharging at 0.2 C, and then the variation of the capacitance of the lithium batteries after multiple charges and discharges is recorded.

TABLE 1

| | | | 1^{st} cycle | | 15^{th} cycle | 15^{th} cycle |
|---|---|---|---|---|---|---|
| | | | discharge | 1^{st} cycle | discharge | recovery |
| | | | capacitance | irreversibility | capacitance | rate |
| Number | | Anode material | (mAh/g) | (%) | (mAh/g) | (%) |
| 1 | Comparative | Carbon material | 165 | 10.0 | 159.3 | 96.6 |
| | Example 1 | | | | | |
| 2 | Comparative | Carbon material + 6.3 | 181.3 | 3.4 | 177.3 | 97 |
| | Example 2 | parts by weight of | | | | |
| | | lithium-containing | | | | |
| | | layer | | | | |
| 3 | Comparative | Carbon material + 0.2 | 172.3 | 7.9 | 162.7 | 94.4 |
| | Example 3 | parts by weight of | | | | |
| | (physical | organic polymer | | | | |
| | adsorption) | | | | | |
| 4 | Example 1 | Carbon material + 0.2 | 172.0 | 2.3 | 169.3 | 98.8 |
| | (physical | parts by weight of | | | | |
| | adsorption) | organic polymer + 6.0 | | | | |
| | | parts by weight of | | | | |
| | | lithium-containing | | | | |
| | | layer | | | | |
| 5 | Comparative | Carbon material + 0.5 | 172.1 | 7.3 | 159.2 | 92.5 |
| | Example 4 | parts by weight of | | | | |
| | (physical | organic monomer | | | | |
| | adsorption) | | | | | |
| 6 | Example 2 | Carbon material + 0.5 | 170.6 | 2.6 | 168.9 | 99.0 |
| | (physical | parts by weight of | | | | |
| | adsorption) | organic monomer + 3.6 | | | | |
| | | parts by weight of | | | | |
| | | lithium-containing | | | | |
| | | layer | | | | |
| 7 | Comparative | Carbon material + 0.7 | 179.9 | 8.0 | 169.3 | 94 |
| | Example 5 | parts by weight of | | | | |
| | (chemical | organic monomer | | | | |
| | grafting) | | | | | |
| 8 | Example 3 | Carbon material + 0.7 | 183.9 | 4.5 | 182.7 | 99 |
| | (chemical | parts by weight of | | | | |
| | grafting) | organic monomer + 4.3 | | | | |
| | | parts by weight of | | | | |
| | | lithium-containing | | | | |
| | | layer | | | | |
| 9 | Comparative | Carbon material + 1.3 | 167.0 | 2.0 | 165 | 96.8 |
| | Example 6 | parts by weight of | | | | |
| | (chemical | organic monomer + 4 | | | | |
| | grafting) | parts by weight of | | | | |
| | | lithium-containing | | | | |
| | | layer | | | | |
| 10 | Comparative | Carbon material + 0.7 | 167.2 | 2.1 | 164.2 | 96.1 |
| | Example 7 | parts by weight of | | | | |
| | (chemical | organic monomer + 24 | | | | |
| | grafting) | parts by weight of | | | | |
| | | lithium-containing | | | | |
| | | layer | | | | |
| 11 | Comparative | Carbon material + 1.3 | 168.2 | 2.2 | 165.5 | 96.8 |
| | Example 8 | parts by weight of | | | | |
| | (chemical | organic monomer + 24 | | | | |
| | grafting) | parts by weight of | | | | |
| | | lithium-containing | | | | |
| | | layer | | | | |

Carbon material: mesophase graphite
Organic polymer: meta-stable nitrogen-containing polymer (copolymer of 2,4-bimethyl-2-imidazoline and maleimide, Mw: 300,000)
Organic monomer: N,N′-(4,4′-diphenylmethane) bismaleimide
Lithium-containing layer: mixture of lithium, lithium oxide, and lithium carbonate

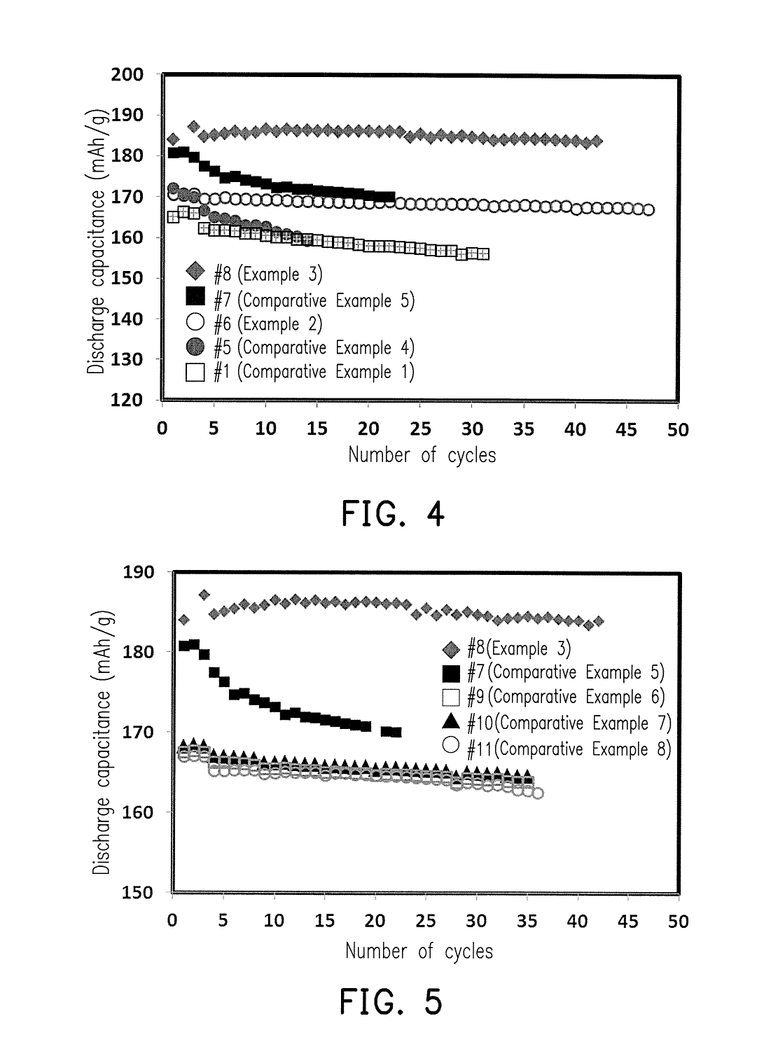

FIG. 4 is a graph of the measurement results of charge and discharge cycles of the lithium battery of each of Examples 2 to 3 and Comparative Examples 1, 4, and 5. FIG. 5 is a graph of the measurement results of charge and discharge cycles of the lithium battery of each of Example 3 and Comparative Examples 5 to 8.

As shown in Table 1 and FIGS. 4 to 5, in the samples of Examples 1 to 3 of the disclosure, the initial properties or the cycle life of the carbon material first modified by an organic material and then modified by supplementing a lithium-containing inorganic layer are both significantly better in comparison to the samples of the Comparative Examples.

Moreover, it is observed that the effect of the lithium ion battery for which chemical bonding occurs between the carbon material and the organic layer (such as the sample of Example 3) is better than that of the lithium ion battery for which chemical bonding does not occur between the carbon material and the organic layer (such as the samples of Examples 1 to 2).

Moreover, it is shown from the test results of the samples of numbers 8 to 11 of Table 1 that, even if the carbon material is modified by the same organic/inorganic materials, a ratio of usage amount of the organic/inorganic materials within the range of the disclosure is still preferred to achieve the best effect. More specifically, when the anode active material consists mainly of a carbon material, based on 100 parts by weight of the anode active material, the organic modified layer accounts for about 0.5 to 1 parts by weight, and the lithium-containing inorganic layer accounts for about 3 to 6 parts by weight. When the usage range is outside the range of the disclosure (such as the samples of Comparative Examples 6 to 8), the capacitance is reduced and the resistance is increased.

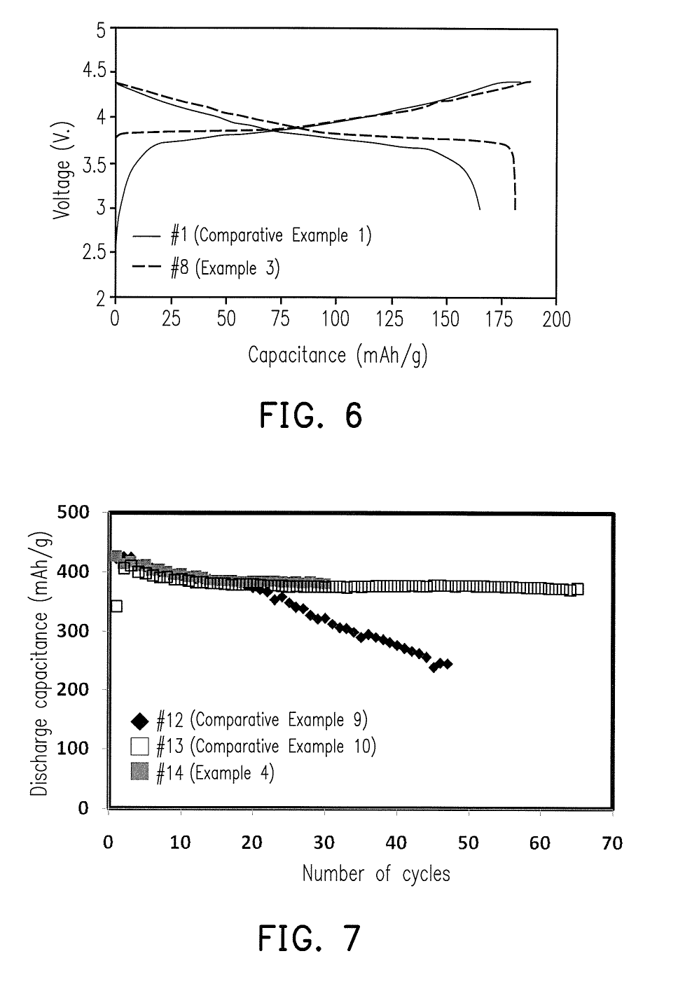

FIG. 6 is a graph of charge/discharge of the lithium battery of each of Example 3 and Comparative Example 1.

As shown in Table 1 and FIG. 6, in comparison to the unmodified carbon material (such as the sample of Comparative Example 1), the carbon material first modified by chemically grafting an organic material and then modified by supplementing a lithium-containing inorganic layer (such as the sample of Example 3) can significantly increase initial capacitance by about 12% (an increase from 165 mAh/g to 181 mAh/g).

Charge and Discharge Cycle Test of Lithium Half-Cell

Two button-type half-cells (size CR2032) are assembled, wherein the cathode electrode plates of the batteries adopt lithium metal, the anode electrode plates adopt materials as shown in Table 2, and the separators are PP/PE/PP three-layer films. The electrolyte solution is formed by dissolving 1.2 M of LiPF₆ in a mixed solvent of ethylene carbonate (EC) and dimethyl carbonate (DMC) (volume ratio EC/DMC=1/2), and then fluorinated ethylene carbonate (FEC) is added in a volume ratio of 5%. A charge and discharge cycle test is performed on the manufactured lithium batteries. Three cycles are performed by charging and discharging at 0.1 C, then the 4^{th} to 65^{th} cycles are performed by charging and discharging at 0.2 C, and then variation of the capacitance of the lithium batteries after multiple charges and discharges is recorded.

TABLE 1

| | | | 1^{st} cycle | | 30^{th} cycle | 30^{th} cycle |
|---|---|---|---|---|---|---|
| | | | discharge | 1^{st} cycle | discharge | recovery |
| | | | capacitance | irreversibility | capacitance | rate |
| Number | | Anode material | (mAh/g) | (%) | (mAh/g) | (%) |
| 12 | Comparative | Si/C composite | 421.9 | 7.8 | 321.5 | 76.2 |
| | Example 9 | material | | | | |
| 13 | Comparative | Si/C composite | 342.1 | 10.1 | 375.1 | 90.2 |
| | Example 10 | material + 3 | | | | |
| | (physical | parts by weight of | | | | |
| | adsorption) | organic polymer | | | | |
| 14 | Example 4 | Si/C composite | 425.5 | 7.0 | 380.7 | 89.5 |
| | (physical | material + 3 | | | | |
| | adsorption) | parts by weight of | | | | |
| | | organic polymer + 17 | | | | |
| | | parts by weight of | | | | |
| | | lithium-containing | | | | |
| | | layer | | | | |

Si/C composite material: composite material of silicon oxide core and carbon/graphite shell
Organic polymer: meta-stable nitrogen-containing polymer (copolymer of 2,4-bimethyl-2-imidazoline and maleimide, Mw: 1,000,000)
Lithium-containing layer: mixture of lithium, lithium oxide, and lithium carbonate

Referring to Table 1 and Table 2, in comparison to the samples of numbers 1 to 11 for which the anode active material is a carbon material, the samples of numbers 12 to 14 for which the anode active material is a Si/C composite material have higher capacitance.

FIG. 7 is a graph of the measurement results of charge and discharge cycles of the lithium half-cell of each of Example 4 and Comparative Examples 9 to 10.

As shown in Table 2 and FIG. 7, by comparing the sample of number 13 (Comparative Example 10) and the sample of number 12 (Comparative Example 9), the initial capacitance of the sample of number 13 is lower than that of the sample of number 12, and the capacitance in battery lifetime performance of the sample of number 13 is better than that of the sample of number 12. Moreover, by comparing the sample of number 14 (Example 4) and the sample of number 12, it is observed that, for the sample of number 14, the capacitance in battery lifetime performance can still be maintained without sacrificing the initial capacitance.

Supplement Lithium Amount Test of Lithium Battery

The anode material of the conventional lithium battery is only formed by a carbon material without any modification. Then, different amounts of a lithium-containing inorganic material (such as a mixture of lithium, lithium oxide, and lithium carbonate) are supplemented to observe the change in initial capacitance. The anode material of the disclosure is first chemically modified by 0.7 parts by weight of N,N′-(4,4′-diphenylmethane)bismaleimide, and then different amounts of the lithium-containing inorganic material are supplemented to observe the change in initial capacitance.

TABLE 3
Conventional lithium battery

| Usage amount of | |
|---|---|
| lithium-containing | 1^{st} cycle discharge |
| inorganic material | capacitance |
| (wt %) | (mAh/g) |
| 0 | 165.6 |
| 5.5 | 179.4 |
| 6.1 | 181.3 |
| 24 | 164.3 |

TABLE 4
Lithium battery of the disclosure

| Usage amount of | |
|---|---|
| lithium-containing | 1^{st} cycle discharge |
| inorganic material | capacitance |
| (wt %) | (mAh/g) |
| 0 | 179.9 |
| 2.6 | 183.9 |
| 5.1 | 184.1 |
| 6.4 | 177.9 |

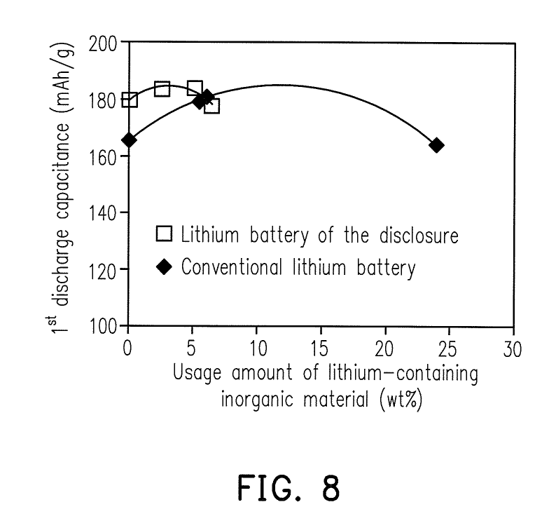

FIG. 8 is a graph of the measurement results of a conventional lithium battery and the lithium battery of the disclosure in different supplement lithium amounts.

As shown in FIG. 8, the lithium battery of the disclosure can take effect in a small supplement lithium amount, but the supplement lithium amount needed for the conventional lithium battery to take effect is far greater than that for the lithium battery of the disclosure. In other words, the disclosure can significantly reduce the supplement lithium amount needed, thus reducing costs and increasing competitiveness.

Based on the above, in the disclosure, a bilayer structure is formed on the anode active material, wherein the organic modified layer in contact with the anode active material can protect the surface of the anode active material to prevent disintegration of the surface after repeated cycles. Moreover, the lithium-containing inorganic layer disposed on the organic modified layer can supplement lithium ions consumed in the cycling process. Therefore, the anode material combination of the disclosure can maintain the structural stability of the anode material in an electrochemical reaction, and can increase the cycle life of long-term charges and discharges.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An anode material for a lithium ion battery, comprising:
an anode active material;
an organic modified layer disposed on the anode active material; and
a lithium-containing inorganic layer disposed on the organic modified layer,
wherein based on 100 parts by weight of the anode active material, the organic modified layer accounts for 0.1 to 5 parts by weight, and the lithium-containing inorganic layer accounts for 0.1 to 20 parts by weight.

2. The anode material of claim 1, wherein chemical bonding occurs between the anode active material and the organic modified layer.

3. The anode material of claim 1, wherein chemical bonding does not occur between the anode active material and the organic modified layer.

4. The anode material of claim 1, wherein the organic modified layer comprises maleimide, furan, thiophene, pyrrole, alkyne, alkene, cycloalkene, a derivative thereof, or a combination thereof.

5. The anode material of claim 1, wherein the organic modified layer comprises N,N′-(4,4′-diphenylmethane)bismaleimide, N-phenyl maleimide, N,N′,N″-(4,4′,4″-phenylmethane)maleimide, N,N′-(4,4′-diphenyl ether)bismaleimide, or a combination thereof.

6. The anode material of claim 1, wherein the organic modified layer comprises polymaleimide having a weight-average molecular weight of 100,000 to 1,000,000 or a derivative thereof.

7. The anode material of claim 1, wherein a thickness of the organic modified layer is from 15 nm to 20 nm.

8. The anode material of claim 1, wherein the lithium-containing inorganic layer comprises at least one of lithium, lithium fluoride (LiF), lithium phosphate (Li₃PO₄), lithium disilicate (Li₂Si₂O₅), lithium metasilicate (Li₂SiO₃), lithium orthosilicate (Li₄SiO₄), lithium oxosilicate (Li₈SiO₆), lithium oxide (Li₂O), and lithium carbonate (Li₂CO₃).

9. The anode material of claim 1, wherein the anode active material comprises graphite, graphene, hard carbon, soft carbon, single-walled carbon nanotubes (SWCNT), multi-walled carbon nanotubes (MWCNT), carbon fiber, carbon alloy, carbon metal oxide, a Si/C composite material, mesocarbon micro beads (MCMB), mesophase graphite, mesoporous graphite, or a combination thereof.

10. The anode material of claim 1, wherein when the anode active material consists mainly of a carbon material, based on 100 parts by weight of the anode active material, the organic modified layer accounts for 0.5 to 1 parts by weight, and the lithium-containing inorganic layer accounts for 3 to 6 parts by weight.

11. The anode material of claim 1, wherein when the anode active material consists mainly of a carbon material and a silicon material, based on 100 parts by weight of the anode active material, the organic modified layer accounts for 1 to 5 parts by weight, and the lithium-containing inorganic layer accounts for 15 to 20 parts by weight.

12. A lithium ion battery, comprising the anode material of claim 1.

13. An anode material for a lithium ion battery, comprising:
a core consisting mainly of an anode active material;
a first shell layer covering the core and consisting mainly of an organic material; and
a second shell layer disposed on the first shell layer and comprising at least one of lithium, lithium fluoride (LiF), lithium phosphate (Li₃PO₄), lithium disilicate (Li₂Si₂O₅), lithium metasilicate (Li₂SiO₃), lithium orthosilicate (Li₄SiO₄), lithium oxosilicate (Li₈SiO₆), lithium oxide (Li₂O), and lithium carbonate (Li₂CO₃).

14. The anode material of claim 13, wherein chemical bonding occurs between the core and the first shell layer.

15. The anode material of claim 13, wherein chemical bonding does not occur between the core and the first shell layer.

16. The anode material of claim 13, wherein based on 100 parts by weight of the core, the first shell layer accounts for 0.1 to 5 parts by weight and the second shell layer accounts for 0.1 to 20 parts by weight.

17. The anode material of claim 13, wherein the organic material comprises maleimide, furan, thiophene, pyrrole, alkyne, alkene, cycloalkene, or a combination thereof.

18. The anode material of claim 13, wherein the organic material comprises polymaleimide having a weight-average molecular weight of 100,000 to 1,000,000 or a derivative thereof.

19. The anode material of claim 13, wherein a thickness of the first shell layer is from 15 nm to 20 nm.

20. The anode material of claim 13, wherein the core comprises graphite, graphene, hard carbon, soft carbon, single-walled carbon nanotubes (SWCNT), multi-walled carbon nanotubes (MWCNT), carbon fiber, carbon alloy, carbon metal oxide, a Si/C composite material, mesocarbon micro beads (MCMB), mesophase graphite, mesoporous graphite, or a combination thereof.
